(19) United States
(12) Patent Application Publication
(10) Pub. No.: US 2016/0291192 A1
(43) Pub. Date: Oct. 6, 2016

(54) CURRENT DENSITY INVERSION

(71) Applicant: WESTERNGECO LLC, Houston, TX (US)

(72) Inventors: Nestor CUEVAS, Milan (IT); Michael WILT, Walnut Creek, CA (US); Ping ZHANG, Albany, CA (US); Jiuping CHEN, San Pablo, CA (US)

(21) Appl. No.: 15/038,237

(22) PCT Filed: Nov. 25, 2014
(86) PCT No.: PCT/US2014/067420

§ 371 Date: May 20, 2016

Related U.S. Application Data
(60) Provisional application No. 61/909,639, filed on Nov. 27, 2013.

(51) Int. Cl. G01V 3/20

(52) U.S. Cl. CPC G01V 3/20

(57) ABSTRACT

Various implementations described herein are directed to a method of performing an electromagnetic survey operation. The method may include measuring an electric field of a subsurface area using sensors in a well disposed within the subsurface area. The method may include computing a first current density by multiplying the electric field with a measured electric resistivity in the well. The method may include creating a resistivity model of the subsurface area. The method may include running a simulation on the resistivity model to create a second current density. The method may include calculating a misfit by comparing the first current density to the second current density. The method may also include adjusting the resistivity model based on the misfit.

### CROSS-REFERENCE TO RELATED APPLICATIONS

This application claims the benefit of U.S. Provisional Patent Application Ser. No. 61/909,639, filed Nov. 27, 2013, titled METHODS AND COMPUTING SYSTEMS FOR PROCESSING AND TRANSFORMING COLLECTED ELECTROMAGNETIC DATA FOR IMPROVED INTERPRETIVE PURPOSES, and the disclosure of which is incorporated herein by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Electromagnetic surface to borehole measurements are used to detect electrically anomalous targets. A transmitter, usually a multi-turn coil of wire or a grounded antenna, carries an alternating current of frequency ω (radians/sec). This creates a time-varying electromagnetic field that flows in the surrounding formation. The electric antenna yields current flow that is distorted by the presence of resistivity anomalies. Magnetic fields induce by Faraday's law an electromotive force (EMF) which drives currents in the formation that are proportional to the formation conductivity. A receiver measures the electric and magnetic field arising from the transmitter and the currents flowing in the formation. Conventional induction logging uses a combination of multiple receivers and/or multiple transmitters connected in series to cancel the mutual signal in air. In general, a theoretical model for a logging system embedded in a formation of arbitrary resistivity is used to match or interpret the received signals.

### SUMMARY

Described herein are implementations of various technologies for a method for performing an electromagnetic survey operation. The method may include measuring an electric field of a subsurface area using sensors in a well disposed within the subsurface area. The method may include computing a first current density by multiplying the electric field with a measured electric resistivity in the well. The method may include creating a resistivity model of the subsurface area. The method may include running a simulation on the resistivity model to create a second current density. The method may include calculating a misfit by comparing the first current density to the second current density. The method may also include adjusting the resistivity model based on the misfit.

Described herein are also implementations of various technologies for a method for performing an electromagnetic survey operation. The method may include measuring an electric field in a subsurface area. The method may include computing a first current density by multiplying the electric field with a measured electric resistivity in a well disposed within the subsurface area. The method may include creating a resistivity model of the subsurface area. The method may include running a simulation on the resistivity model to create a second current density. The method may include calculating a misfit by comparing the first current density to the second current density. The method may also include adjusting the resistivity model until the misfit is less than a selected misfit level.

Described herein are also implementations of various technologies for a non-transitory computer-readable medium having stored thereon computer-executable instructions which, when executed by a computer, cause the computer to perform various actions. The actions may include receiving a measured electric field and a first magnetic field for a subsurface area. The actions may include computing a first current density by multiplying the electric field with a measured electric resistivity of a well disposed inside the subsurface area. The actions may include creating a three dimensional resistivity model of the subsurface area. The actions may include running a simulation using the three dimensional resistivity model to create a second current density and a second magnetic field. The actions may include calculating a misfit by comparing the first current density to the second current density and the first magnetic field to the second magnetic field. The actions may also include adjusting the three dimensional resistivity model to reduce the misfit.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates an electromagnetic surface to borehole survey in accordance with implementations of various techniques described herein.

FIG. 2 is a flow diagram of a method for a current density inversion in accordance with implementations of various techniques described herein.

FIG. 3 illustrates current density and electromagnetic field data in accordance with implementations of various techniques described herein.

FIG. 4 illustrates a schematic diagram of a computing system in which the various technologies described herein may be incorporated and practiced.

### DETAILED DESCRIPTION

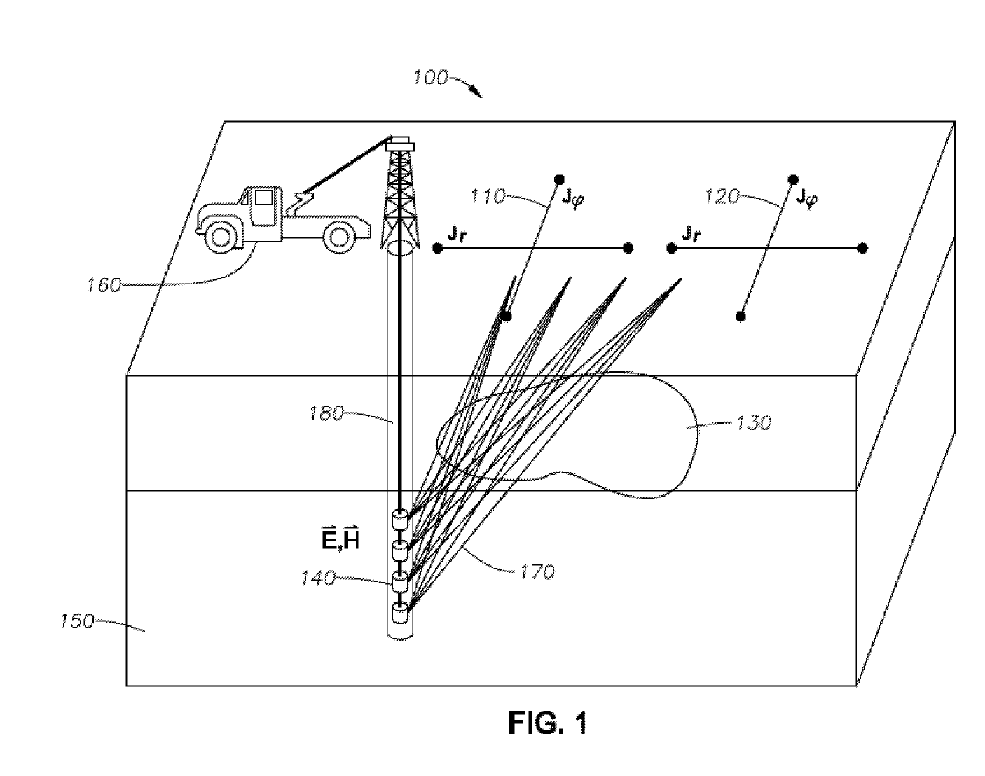

Various implementations described herein will now be described in more detail with reference to FIGS. 1-4.

FIG. 1 illustrates an electromagnetic surface to borehole survey 100 in accordance with implementations of various techniques described herein. The electromagnetic surface to borehole survey 100 may be used to detect geological formations and monitor the presence of fluids around a well.

Electromagnetic sources, including surface radial and azimuthal antennae 110 and 120, may emit electric currents, electromagnetic fields, or other electromagnetic perturbations, into the ground 150. The electromagnetic sources may be positioned above a subsurface area. The currents travel through a formation 130 and the earth 150. The currents may cause secondary magnetic fields 170 to be created. The secondary magnetic fields 170 are then detected by receivers 140 in a borehole 180, which is in the subsurface area. During a survey, the antennae 110 and 120 may be moved to multiple locations. At each location, the antennae 110 and 120 may emit electric current, and one or more measurements may be taken using the receivers 140.

The electromagnetic surface to borehole survey 100 may be used to detect the interface between different substances or layers. Different substances in the earth may have different resistivity. These changes in resistivity over space may be reflected in the measurements of the secondary magnetic fields 170. For example, an oil reservoir may be detected as resistive, and water may be detected as conductive. The contact between oil and water may be sensitive to electromagnetic fields, and may be detected using the surface to borehole survey 100.

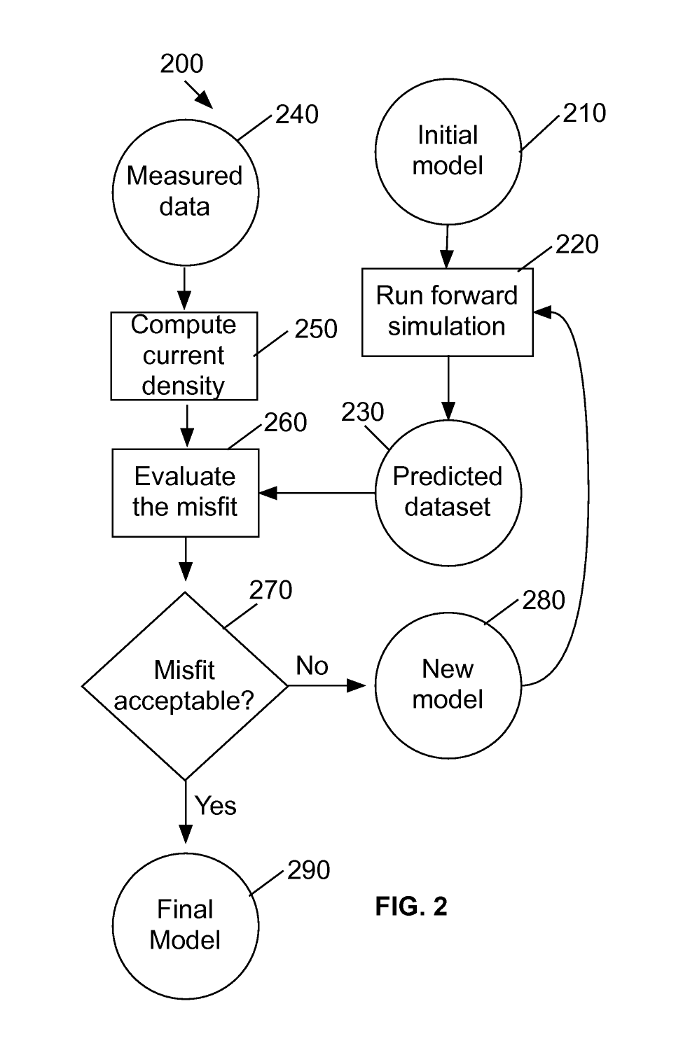

Changes in subsurface resistivity may be approximated in a generated three dimensional (“3D”) model of the subsurface. The measurements taken using the receivers 140 located in the borehole 180 may be transmitted from the receivers 140 to a truck 160 on the surface. The measured data may then be stored in a database that comprises source positions and the measured data associated with each position of the antennae 110 and 120. The measured data may be used to build a 3D resistivity model of the formation 130 and earth 150. In one implementation, the resistivity in the borehole may be known, and the 3D resistivity model may be constructed to approximate the resistivity surrounding the borehole. This model building process may be referred to as an inversion. The 3D resistivity model may be used to determine the locations of resistivity inhomogeneities or a distribution of electrical properties in the subsurface area. One example of a method for performing this inversion is described in FIG. 2.

FIG. 2 is a flow diagram of a method 200 for a current density inversion in accordance with implementations of various techniques described herein. In one implementation, method 200 may be performed by a computer system 400. It should be understood that while method 200 indicates a particular order of execution of operations, in some implementations, certain portions of the operations might be executed simultaneously, in a different order, or on different systems. Further, in some implementations, additional operations or steps may be added to the method 200. Likewise, some operations or steps may be omitted.

At block 210, an initial 3D earth resistivity model, referred to as σ(x, y, z), may be generated, where σ referes to the electrical conductivity or resistivity of the earth. The electrical resistivity, σ, may be measured in units of Siemens per meter (S/m). The 3D model may be a model of a subsurface area surrounding and including a well or borehole. The initial model may include measured data describing resistivity in the borehole. In one implementation, the initial model may be created using known geologic features of the modeled area. For example, the initial model may be created based on a known location of an interface between water and oil. In another implementation, the initial model may include a homogenous resistance for areas outside of the borehole. For example, in the initial model, the resistivity may be 1 Siemen/meter for all areas outside of the borehole. In this example, the resistivity within the borehole is a known quantity because it has been measured, and that measured data is incorporated within the model. In yet another implementation, the initial model may be a resistivity model with an inhomogeneous resistance throughout the subsurface area. For example, a prediction of water and oil saturation in the subsurface area may be made, and then a resistivity model may be determined by a law, such as Archie's law.

At block 220, a forward simulation is run on the initial model σ(x, y, z). The forward simulation generates a predicted dataset, illustrated at block 230. The predicted dataset may comprise a predicted vertical current density J(z), a predicted vertical electric field E(z) and a predicted magnetic field H(z). The predicted current density J(z) may be calculated using the formula J(z)=σ(x, y, z)·E(z). In this formula, the initial 3D earth model σ(x, y, z) is multiplied by the prediced vertical electric field E(z) in order to generate a predicted vertical current density J(z).

Block 240 illustrates measured data. The measured data may include a measured vertical electric field E₀(z) and a magnetic field H₀(z).

At block 250, the vertical current density J₀(z) may be calculated. A measurement of electrical conductivity or resistivity in a well, σ_{w}, may be used to calculate the current density. The resistivity in the well, σ_{w}, may be retrieved from well logs or well log measurements. For example, when a well is drilled, the resistivity may be measured by a resistivity logging device and stored in a log. The current density may be calculated using the formula J₀(z)=σ_{w}E₀(z). In this formula, the measured vertical electric field E₀(z) is multiplied by resistivity σ_{w} in order to generate the current density J₀(z).

At block 260, the misfit between the measured and predicted data may be evaluated by comparing the measured vertical current density with the predicted vertical current density. In one implementation, the misfit may be calculated by comparing the measured vertical current density with the predicted vertical current density and by comparing the measured vertical magnetic field with the predicted magnetic field. The current density J₀(z) and magnetic field H₀(z) may be compared to the predicted density J(z) and predicted magnetic field H(z) in order to evaluate the misfit of the model σ(x, y, z). This comparison is illustrated in the equation M:f(|J₀(z)−J(z)|, |H₀(z)−H(z)|), where M is the computed misfit. For example, a misfit may be calculated, and the calculated misfit may then be compared to a preset maximum amount of error. In one implementation, the misfit may be calculated by determining the absolute value of the difference between the predicted and measured current density or magnetic field. In another implementation, the misfit may be calculated by squaring the difference between the predicted and measured current density or magnetic field.

At block 270, the method will determine whether the misfit is acceptable. If the misfit is acceptable, then the model σ(x, y, z) is the final model at block 290 and the method is complete. If the misfit is not acceptable, then the method continues to block 280.

At block 280, the model σ(x, y, z) may be adjusted in order to create a new model. In order to adjust the model, conductivity may be added or subtracted from the 3D model σ(x,y,z). For example, the new model may be described as σ(x, y, z)=σ(x, y, z)+Δσ(x, y, z), where Δσ(x, y, z) is the adjustment to the model. In one implementation, an optimization algorithm may be applied to the model in order to adjust the model. After adjusting the model, the method 200 repeats blocks 220-270 until a model with an acceptable misfit, i.e., an acceptable amount of error, is achieved. The object of the iterative process described in blocks 210-280 is to yield a model in block 290 with a calculated electromagnetic response that matches the measured electromagnetic fields.

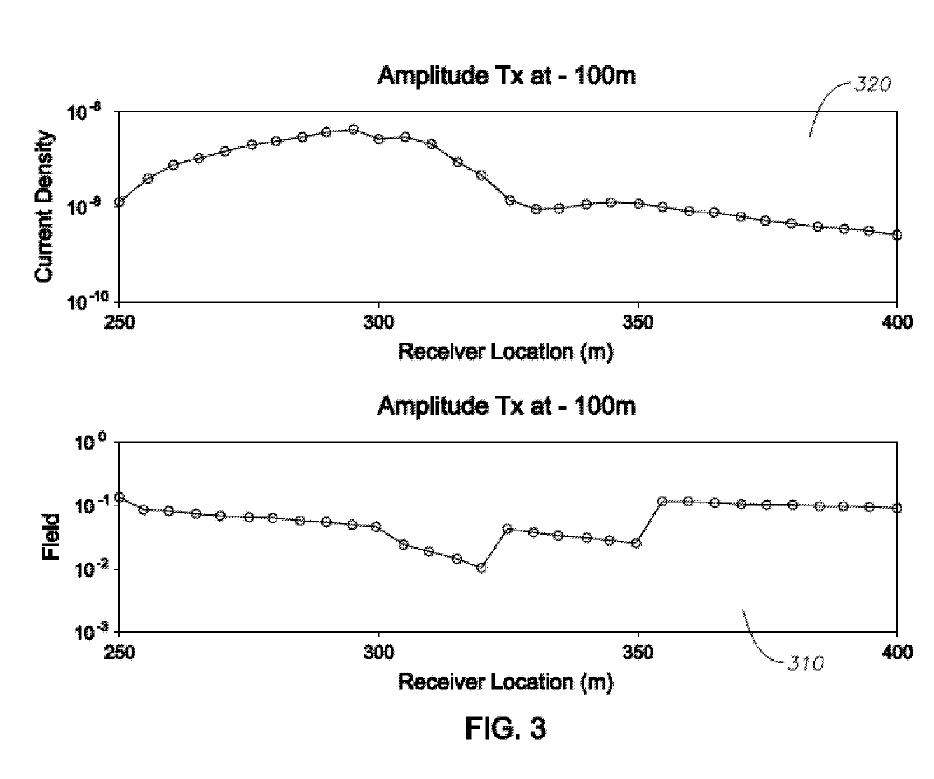

FIG. 3 illustrates current density and electromagnetic field data in accordance with implementations of various techniques described herein. Graph 310 illustrates a depth profile of a vertical electric field. At approximately 325 meters and 350 meters sharp discontinuities can be seen in the electric field measurements. These discontinuities are useful in that they indicate likely interfaces between layers. For example, the profile may traverse from a reservoir layer to a basement layer. Unfortunately, these discontinuities may lead to complications when building a 3D earth model that corresponds to the measured data. For example, the discontinuities can lead to decreased accuracy of the model, or an increase in the amount of time required to build the model.

Graph 320 illustrates vertical current density. In graph 320, unlike in graph 310, there is no discontinuity in the vertical current density, even as the data crosses layers. This is because the normal (perpendicular to the interface) component of current density is continuous. Because the vertical current density profile does not have the discontinuities that are present in the vertical electric field profile, as shown in graph 310, the process for creating a 3D earth model may be more efficient for the vertical current density than for the vertical electric field profile. For example, the amount of time required to build a 3D model may be reduced if current density is used instead of electric field.

In some implementations, a method for performing an electromagnetic survey operation may be provided. The method may measure an electric field of a subsurface area using sensors in a well disposed within the subsurface area. The method may compute a first current density by multiplying the electric field with a measured electric resistivity in the well. The method may create a resistivity model of the subsurface area. The method may run a simulation on the resistivity model to create a second current density. The method may calculate a misfit by comparing the first current density to the second current density. The method may adjust the resistivity model based on the misfit.

In some implementations, the method may also measure a first magnetic field of the subsurface area and run a simulation on the resistivity model to predict a second magnetic field. Calculating the misfit may comprise comparing the first magnetic field to the second magnetic field. Calculating the misfit may comprise determining an absolute value of a difference between the first magnetic field and the second magnetic field or squaring the difference between the first magnetic field and the second magnetic field. Creating the resistivity model of the subsurface area may comprise creating a resistivity model with a homogenous or inhomogeneous resistance throughout the subsurface area. The electric field may comprise a plurality of measurements that correspond to sources at a plurality of locations above the subsurface area. Measuring the electric field may comprise emitting electric current using sources positioned above the subsurface area and measuring the earth's response to the emitted electric current. Adjusting the resistivity model based on the misfit may comprise adjusting the resistivity model in order to reduce the misfit. The measured electric resistivity in the well may be measured before the electromagnetic survey operation is performed. The resistivity model may be used to determine locations of resistivity inhomogeneities in the subsurface area, a location of a water or an oil reservoir in the subsurface area, or a distribution of electrical properties in the subsurface area. Calculating the misfit may comprise determining an absolute value of a difference between the first current density and the second current density or squaring the difference between the first current density and the second current density.

In some implementations, a computer readable storage medium is provided, which has stored therein one or more programs, the one or more programs including instructions, which when executed by a processor, cause the processor to receive a measured electric field and a first magnetic field for a subsurface area. The programs may further include instructions, which cause the processor to compute a first current density by multiplying the electric field with a measured electric resistivity of a well disposed inside the subsurface area. The programs may further include instructions, which cause the processor to create a three dimensional (3D) resistivity model of the subsurface area. The programs may further include instructions, which cause the processor to run a simulation using the 3D resistivity model to create a second current density and a second magnetic field. The programs may further include instructions, which cause the processor to calculate a misfit by comparing the first current density to the second current density and the first magnetic field to the second magnetic field. The programs may further include instructions, which cause the processor to adjust the 3D resistivity model to reduce the misfit. In some implementations, the instructions which cause the processor to adjust the 3D resistivity model to reduce the misfit comprise instructions which cause the processor to add or subtract resistivity from the 3D resistivity model.

In some implementations, an information processing apparatus for use in a computing system is provided, and includes means for measuring an electric field of a subsurface area using sensors in a well disposed within the subsurface area. The information processing apparatus may also have means for computing a first current density by multiplying the electric field with a measured electric resistivity in the well. The information processing apparatus may also have means for creating a resistivity model of the subsurface area. The information processing apparatus may also have means for running a simulation on the resistivity model to create a second current density. The information processing apparatus may also have means for calculating a misfit by comparing the first current density to the second current density. The information processing apparatus may also have means for adjusting the resistivity model based on the misfit.

In some implementations, a computing system is provided that includes at least one processor, at least one memory, and one or more programs stored in the at least one memory, wherein the programs include instructions, which when executed by the at least one processor cause the computing system to measure an electric field of a subsurface area using sensors in a well disposed within the subsurface area. The programs may further include instructions to cause the computing system to compute a first current density by multiplying the electric field with a measured electric resistivity in the well. The programs may further include instructions to cause the computing system to create a resistivity model of the subsurface area. The programs may further include instructions to cause the computing system to run a simulation on the resistivity model to create a second current density. The programs may further include instructions to cause the computing system to calculate a misfit by comparing the first current density to the second current density. The programs may further include instructions to adjust the resistivity model based on the misfit.

### Computing System

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, cloud computing systems, virtual computers, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

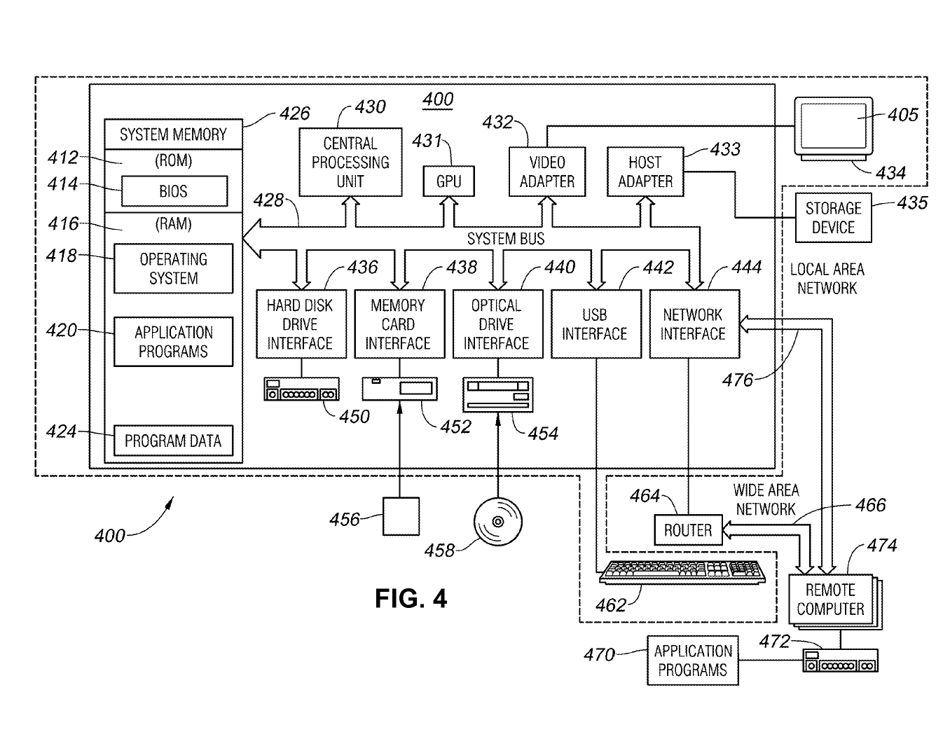

FIG. 4 illustrates a computer system 400 into which implementations of various technologies and techniques described herein may be implemented. Computing system 400 may be a conventional desktop, a handheld device, a wearable device, a controller, a server computer, an electronic device/instrument, a laptop, or a tablet. It should be noted, however, that other computer system configurations may be used.

The computing system 400 may include a central processing unit (CPU) 430, a system memory 426 and a system bus 428 that couples various system components including the system memory 426 to the CPU 430. Although only one CPU 430 is illustrated in FIG. 4, it should be understood that in some implementations the computing system 400 may include more than one CPU 430.

The CPU 430 can include a microprocessor, a microcontroller, a processor, a programmable integrated circuit, or a combination thereof. The CPU 430 can comprise an off-the-shelf processor such as a Reduced Instruction Set Computer (RISC), including an Advanced RISC Machine (ARM) processor, or a Microprocessor without Interlocked Pipeline Stages (MIPS) processor, or a combination thereof. The CPU 430 may also include a proprietary processor. The CPU may include a multi-core processor.

The CPU 430 may provide output data to a Graphics Processing Unit (GPU) 431. The GPU 431 may generate graphical user interfaces that present the output data. The GPU 431 may also provide objects, such as menus, in the graphical user interface. A user may provide inputs by interacting with the objects. The GPU 431 may receive the inputs from interaction with the objects and provide the inputs to the CPU 430. In one implementation, the CPU 430 may perform the tasks of the GPU 431. A video adapter 432 may be provided to convert graphical data into signals for a monitor 434. The monitor 434 includes a screen 405. The screen 405 can be sensitive to heat or touching (now collectively referred to as a “touch screen”). In one implementation, the computer system 400 may not include a monitor 434.

The GPU 431 may be a microprocessor specifically designed to manipulate and implement computer graphics. The CPU 430 may offload work to the GPU 431. The GPU 431 may have its own graphics memory, and/or may have access to a portion of the system memory 426. As with the CPU 430, the GPU 431 may include one or more processing units, and each processing unit may include one or more cores.

The system bus 428 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 426 may include a read only memory (ROM) 412 and a random access memory (RAM) 416. A basic input/output system (BIOS) 414, containing the basic routines that help transfer information between elements within the computing system 400, such as during start-up, may be stored in the ROM 412. The computing system may be implemented using a printed circuit board containing various components including processing units, data storage memory, and connectors.

The computing system 400 may further include a hard disk drive 436 for reading from and writing to a hard disk 450, a memory card reader 452 for reading from and writing to a removable memory card 456 and an optical disk drive 454 for reading from and writing to a removable optical disk 458, such as a CD ROM, DVD ROM or other optical media. The hard disk drive 450, the memory card reader 452 and the optical disk drive 454 may be connected to the system bus 428 by a hard disk drive interface 436, a memory card interface 438 and an optical drive interface 440, respectively. The drives and their associated computer-readable media may provide nonvolatile storage of computer-readable instructions, data structures, program modules and other data for the computing system 400.

Although the computing system 400 is described herein as having a hard disk 450, a removable memory card 456 and a removable optical disk 458, it should be appreciated by those skilled in the art that the computing system 400 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, including a Solid State Disk (SSD), CD-ROM, digital versatile disks (DVD), or other optical storage, magnetic cassettes, magnetic tape, magnetic disk storage or other magnetic storage devices, or any other medium which can be used to store the desired information and which can be accessed by the computing system 400. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. The computing system 400 may also include a host adapter 433 that connects to a storage device 435 via a small computer system interface (SCSI) bus, a Fiber Channel bus, an eSATA bus, or using any other applicable computer bus interface. The computing system 400 can also be connected to a router 464 to establish a wide area network (WAN) 466 with one or more remote computers 474. The router 464 may be connected to the system bus 428 via a network interface 444. The remote computers 474 can also include hard disks 472 that store application programs 470.

In another implementation, the computing system 400 may also connect to one or more remote computers 474 via local area network (LAN) 476 or the WAN 466. When using a LAN networking environment, the computing system 400 may be connected to the LAN 476 through the network interface or adapter 444. The LAN 476 may be implemented via a wired connection or a wireless connection. The LAN 476 may be implemented using Wi-Fi technology, cellular technology, or any other implementation known to those skilled in the art. The network interface 444 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 474. It will be appreciated that the network connections shown are exemplary and other means of establishing a communications link between the computer systems may be used. The network interface 444 may also include digital cellular networks, Bluetooth, or any other wireless network interface.

A number of program modules may be stored on the hard disk 450, memory card 456, optical disk 458, ROM 412 or RAM 416, including an operating system 418, one or more application programs 420, program data 424 and a database system. The one or more application programs 420 may contain program instructions configured to perform method 200 according to various implementations described herein. The operating system 418 may be any suitable operating system that may control the operation of a networked personal or server computer, such as Windows® XP, Mac OS® X, Unix-variants (e.g., Linux® and BSD®), Android®, iOS®, and the like.

A user may enter commands and information into the computing system 400 through input devices such as a keyboard 462 and pointing device. Other input devices may include a microphone, joystick, satellite dish, scanner, user input button, or the like. These and other input devices may be connected to the CPU 430 through a USB interface 442 coupled to system bus 428, but may be connected by other interfaces, such as a parallel port, Bluetooth or a game port. A monitor 405 or other type of display device may also be connected to system bus 428 via an interface, such as a video adapter 432. In addition to the monitor 434, the computing system 400 may further include other peripheral output devices such as speakers and printers.

The detailed description is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference has been made in detail to various implementations, examples of which are illustrated in the accompanying drawings and figures. In the detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for performing an electromagnetic survey operation, comprising:
measuring an electric field of a subsurface area using sensors in a well disposed within the subsurface area;
computing a first current density by multiplying the electric field with a measured electric resistivity in the well;
creating a resistivity model of the subsurface area;
running a simulation on the resistivity model to create a second current density;
calculating a misfit by comparing the first current density to the second current density; and
adjusting the resistivity model based on the misfit.

2. The method of claim 1, further comprising:
measuring a first magnetic field of the subsurface area;
running a simulation on the resistivity model to predict a second magnetic field; and
wherein calculating the misfit further comprises comparing the first magnetic field to the second magnetic field.

3. The method of claim 2, wherein calculating the misfit comprises determining an absolute value of a difference between the first magnetic field and the second magnetic field or squaring the difference between the first magnetic field and the second magnetic field.

4. The method of claim 1, wherein creating the resistivity model of the subsurface area comprises creating a resistivity model with a homogenous resistance throughout the subsurface area.

5. The method of claim 1, wherein creating the resistivity model of the subsurface area comprises creating a resistivity model with an inhomogeneous resistance throughout the subsurface area.

6. The method of claim 1, wherein the electric field comprises a plurality measurements that correspond to sources at a plurality of locations above the subsurface area.

7. The method of claim 1, wherein measuring the electric field comprises:
emitting electric current using sources positioned above the subsurface area; and
measuring the earth's response to the emitted electric current.

8. The method of claim 1, wherein adjusting the resistivity model based on the misfit comprises adjusting the resistivity model in order to reduce the misfit.

9. The method of claim 1, wherein the measured electric resistivity in the well is measured before the electromagnetic survey operation is performed.

10. The method of claim 1, wherein the resistivity model is used to determine locations of resistivity inhomogeneities in the subsurface area.

11. The method of claim 1, wherein the resistivity model is used to determine a location of water or an oil reservoir in the subsurface area.

12. The method of claim 1, wherein the resistivity model is used to determine a distribution of electrical properties in the subsurface area.

13. The method of claim 1, wherein calculating the misfit comprises determining an absolute value of a difference between the first current density and the second current density or squaring the difference between the first current density and the second current density.

14. A method for performing an electromagnetic survey operation, comprising:
measuring an electric field in a subsurface area;
computing a first current density by multiplying the electric field with a measured electric resistivity in a well disposed in the subsurface area;
creating a resistivity model of the subsurface area;
running a simulation on the resistivity model to create a second current density;
calculating a misfit by comparing the first current density to the second current density; and
adjusting the resistivity model until the misfit is less than a selected misfit level.

15. The method of claim 14, wherein creating the resistivity model comprises creating a resistivity model with a homogenous resistance throughout the subsurface area.

16. The method of claim 14, wherein the measured electric resistivity in the well is measured before the electromagnetic survey operation is performed.

17. The method of claim 14, wherein the measured electric resistivity in the well is obtained from well log measurements.

18. The method of claim 14, wherein the measured electric resistivity in the well is obtained using a resistivity logging device.

19. A non-transitory computer readable medium having stored thereon a plurality of computer-executable instructions which, when executed by a computer, cause the computer to:
receive a measured electric field and a first magnetic field for a subsurface area;
compute a first current density by multiplying the electric field with a measured electric resistivity of a well disposed inside the subsurface area;
create a three dimensional (3D) resistivity model of the subsurface area;
run a simulation using the 3D resistivity model to create a second current density and a second magnetic field;
calculate a misfit by comparing the first current density to the second current density and the first magnetic field to the second magnetic field; and
adjust the 3D resistivity model to reduce the misfit.

20. The non-transitory computer readable medium of claim 19, wherein the computer-executable instructions that cause the computer to adjust the 3D resistivity model to reduce the misfit comprise computer-executable instructions that cause the computer to add or subtract resistivity from the 3D resistivity model.
